(19) United States
(12) Patent Application Publication
(10) Pub. No.: US 2013/0033565 A1
(43) Pub. Date: Feb. 7, 2013

(54) Three-coordinate Three Dimensional Television system in Cubic and Spherical configurations, with Domed Theater Display and other curved shapes

(71) Applicant: Harlan Ray Sandidge, Ft. Worth, TX (US)

(72) Inventor: Harlan Ray Sandidge, Ft. Worth, TX (US)

(21) Appl. No.: 13/162,785

(22) Filed: Aug. 3, 2011

(51) Int. Cl. H04N 13/04

(52) U.S. Cl. 348/36; 348/E13.026

(57) ABSTRACT

This invention provides a means to present television in full, actual space, not an illusionistic or stereoscopic type of viewer. The first camera and viewer was cubic in shape, and provided a distancing coordinate for a more conventional flat display This was first described and illustrated in a 1999 patent application for a overall system of television manufacture.

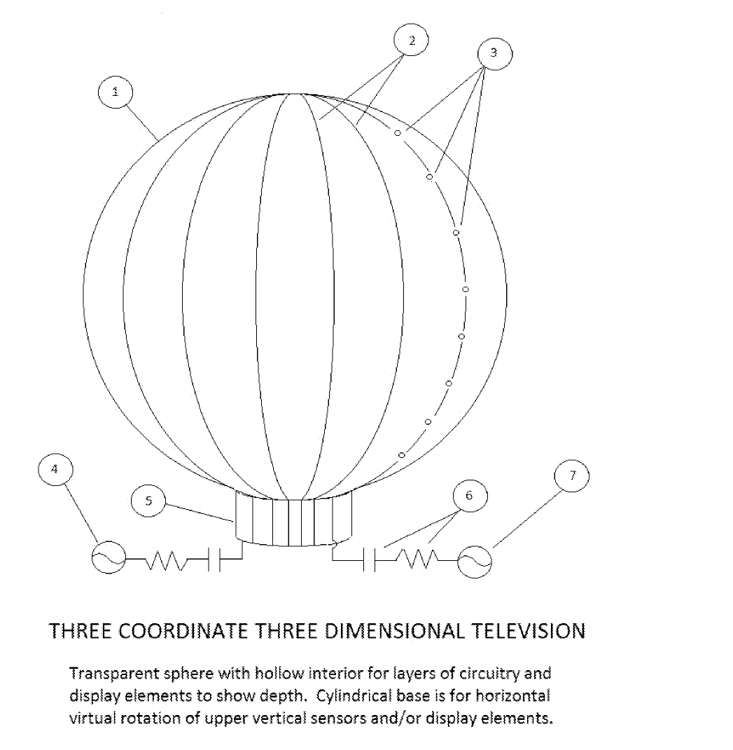

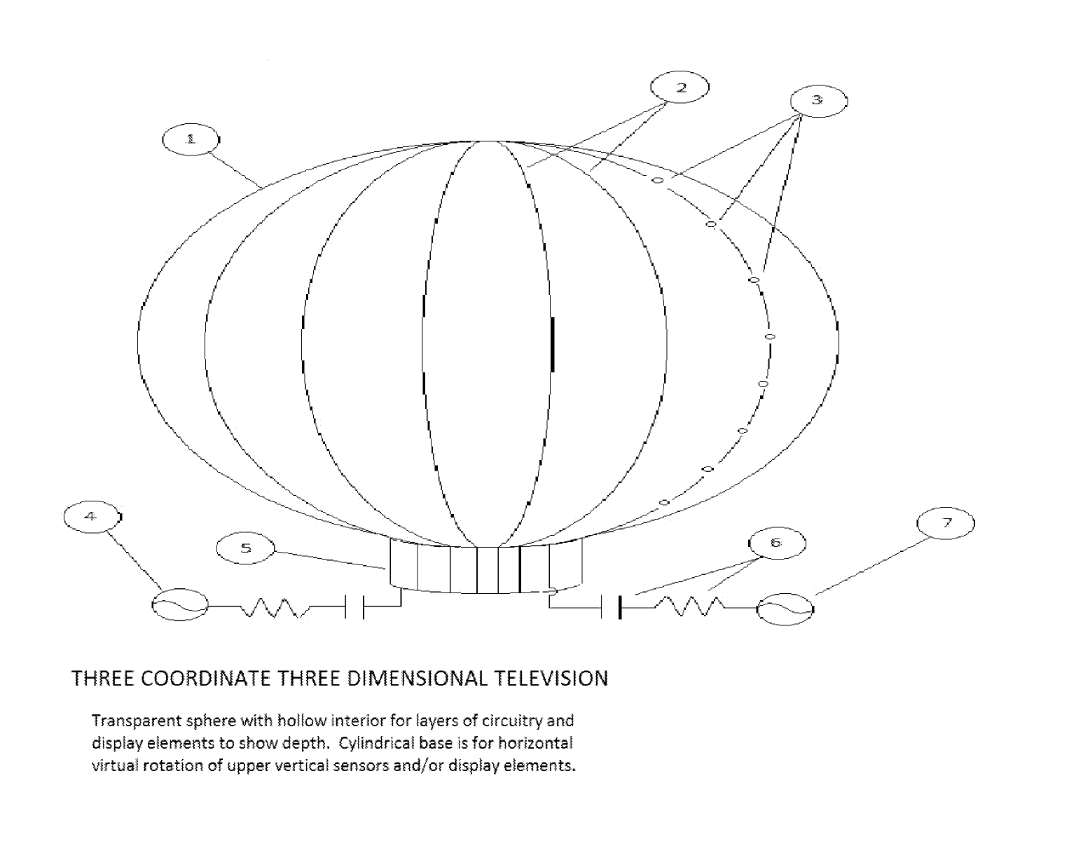

At some point the idea of a spherical model was also described, with a drawing of a sphere with vertical and horizontal elements. Two versions of a spherical model are described in the present application, one with horizontally placed “disks” and a mechanically rotated vertical rod with photo sensitive and radar or sonar devices for the distancing function.

The advanced model was entirely digital and sequential and “rotated” sequentially both horizontally and vertically to create a solid sphere of vision and presentation.

A completely different way to create and display television is hereby provided. Instead of a closed box camera, this is an open system reacting to the environment digitally with specialized, localized, narrow or tunnelled, or otherwise polarized or restricted “dot” vision, which is added together sequentially to provide a 360 degree vertical and horizontal display to display in the “round” with the appearance of a “crystal ball,” or in a domed theater unit.

A variant of this base model can have additional “multiple eyes,” insectazoid multiple camera systems added on, with additional coordinates to be provided.

The camera and display can be described as a spherically shaped object made out of transparent materials so that interior structures can be seen upon illumination of the various coordinates within, arranged in layers, or spheres within spheres, as in a round onion. Either the various spheres within are reduced in size copies of the exterior shell, or a process will cause the sphere of the correct depth to be properly proportional and illuminated. Thus, three coordinates are used to determine the correct angle vertically and horizontally, and a laser, sonar, or radar system will provide the depth representation.

The description and drawing provided will show in an easy to understand way how the coordinates can work. Imagine a sphere with a series of vertical lines (a very high number, miniaturized.) At the bottom of the sphere is a small cylindrical object or base, which can hold the horizontal sequential switching electronics, although the use of a mechanical disk or rotator could be used.

A regular, systematic virtual rotation can be maintained by a quartz or other stabilizer to the unit. The horizontal sequencers will systematically trigger the “rotation” of the vertical strip-like displays, as they in turn “rotate” around the sphere quickly in minute advancements.

A miniature laser can be paired with each light sensor for depth perception, and alternate strips of color sensing or value sensing delineation can also be made, or that can be taken care of in the “eye” or exterior multiple camera model or mode.

Further explanations of the notations:

1. This is the total sphere with external sensor/display structures.

2. These are the vertical displays.

3. These are the individual sensor/display units.

4. This shows the signal generator and sequential circuitry for the horizontal switching of the vertical sequential displays.

5. This is the base and housing for circuitry for sequential horizontal action.

6. Sequential circuitry.

7. Signal generator for vertical sequencing.

1. I claim to be the first person to come up with actual three dimensional television (not an illusion of dimensionality, as in split screen technology.) The technology for a cube shaped display and camera was described prior to 1999 in an earlier patent application of mine, using flat panels parallel to the original flat panel viewing surface used for non-3d viewing. I am applying that concept to this, the present application, and seeking protection.

2. I also had the first proposal for a domed theater screen using digital and sequential means for camera and display. I also suggested the first idea of a digital spherical display.

3. My present application is the first to describe a totally spherically orientated television display which uses a three-coordinate system to display in actual physical dimensions. This display can use actual revolving disks, or a special circuitry with no mechanical means of switching or physical scanning.

4. A totally new optical system is devised in this new invention. Instead of a closed eye concept using a lens, as in a boxed camera enclosure, the new idea is an open, spherical design with sensors on the exterior of the sphere. Instead of focusing an image on an interior surface, the new system selects tiny portions of the 360 degree viewing area, and systematizes it for replay.

5. There are several possible ways to arrange the scanning, but my latest choice is to have vertically arranged, single rows of sensors in the camera phase; or lights, transistors, or plasma in the display phase. I claim the possible use of all variations. These vertically orientated streams of sequentially lit lights or elements would in turn be sequentially keyed by horizontally orientated mechanisms (such as a spinning disk,) or by virtual, electronic sequencers.
The vertical sequential motion conforms to the circular shape of the surface of the sphere, going first up one side of the sphere and down the other in a circular rotation. The horizontal sequencer would switch to the next string, and a horizontal movement of the vertical scan would progress onward, scanning each and every point of the sphere in a systematic process.

6. I claim this basic process, whether or not it is achieved by rotating disks or by electronic sequencing. It is based upon the three coordinate concept.

7. I also claim the idea of the circular disk shape, which conforms to the shape of the sphere (contrary to a horizontally rotating square array, for example.)

8. I also claim the cube model which uses parallel panels and radar or other methods of determining the depth of objects and displaying them proportionally in a display.
